(19) United States
(12) Patent Application Publication
(10) Pub. No.: US 2016/0265275 A1
(43) Pub. Date: Sep. 15, 2016

(54) CONSUMABLE AND DISPOSABLE CARTRIDGES FOR LAMINAR SCREENS FEATURING STRAIGHT AND CURVED SHAPES

(71) Applicant: Marcelo ROSELL ROSELL, Font Pineda-Palleja (Barcelona) (ES)

(72) Inventor: Marcelo ROSELL ROSELL, Font Pineda-Palleja (Barcelona) (ES)

(21) Appl. No.: 15/029,608

(22) PCT Filed: Oct. 31, 2014
(86) PCT No.: PCT/ES2014/070818

§ 371 Date: Apr. 14, 2016

(30) Foreign Application Priority Data
Nov. 4, 2013 (ES) P201301046

(51) Int. Cl. E06B 9/58; A47K 3/38; E06B 9/54; E06B 9/42; E06B 9/60; E06B 9/78

(52) U.S. Cl. CPC E06B 9/58; E06B 9/60; E06B 9/78; E06B 9/54; E06B 9/42; A47K 3/38; E06B 2009/543

(57) ABSTRACT

A consumable and disposable cartridge for laminar roller screens featuring quick installation and replacement by means of clip type means or the like, comprising a peripheral frame of an open space to be enclosed. They comprise a flexible sheet which can change between a straight lined, curved or right angled path and tubular angled casings for changing from a straight path into an angled path of the flexible sheet. Inside of it there is a rotation drum for a flexible sheet, a torsion spring causing the rotation drum to rotate so as to roll the sheet and a tubular element being of the same height as the sheet. An actuation knob regulates the spring tension, and a tubular casing delimiting the cartridge. It comprises anchoring and guiding means of the spring inside the drum.

### OBJECT OF THE INVENTION

The invention relates to a consumable and disposable cartridge system, featuring quick installation and replacement thereof by the user, with neither tools nor professional aid required, to accomplish any type of laminar roller screens, applicable to mosquito nets, awnings, door and window curtains, bath and shower screens and other similar applications.

### BACKGROUND OF THE INVENTION

Currently, there are different screens intended to be positioned on baths and showers sides in order to prevent water from splashing outside the area delimited by the brick and mortar work walls, and by the screen itself. Generally, these screens have a peripheral frame on which there are some elements mounted intended to allow the closure of the inner space while being used.

In some cases, these closure elements consist of opening or sliding panels, generally made of glass, mounted on guides defined in the upper and lower uprights of the frame. When these panels are overlaid they leave a partial opening for the user, and when they are longitudinally displaced they determine the closure of the peripheral frame.

These screens feature different problems, such as the difficulty in cleaning thereof, their weight being too heavy for a correct operation of the doors upon opening the corresponding space, or the breaking risk of said doors glass.

There are also some screens in which the closure element is formed by a flexible sheet of a plastic material which can be arranged rolling up on a rotating drum, leaving free access to the whole inner area of the peripheral frame, or totally extended in the closing position of said open space.

In this type of screen, the flexible sheet rolls up over the rotating drum because of the action of preloaded torsion springs acting on said rotating drum, which tend to cause rotation thereof in the rolling direction of the sheet over the drum.

So far, there have been described roller screens in which the rotating drum, and the means causing rotation thereof for the rolling-unrolling of the sheet, are mounted within one of the vertical profiles or uprights, or are part of the same vertical profile or upright which makes up the peripheral frame. These screens have a slot for the flexible sheet to come out.

In these roller systems that have been described, the means to repair the mechanisms and elements have the disadvantages of having to proceed to totally or partially dismount the upright, which has the rolling means inside thereof, and which in turn is fixed to the walls of the building, being necessary to remove the peripheral frame which it is part of. This makes it necessary to employ qualified technicians for a repair action which is not always possible. In case said repair is not possible the screen must be removed and replaced by a new enclosure model.

Documents WO02/065884, WO2004/054419, ES 2020454, ES1033753, ES1034999, ES1036044, for example, are known from the state of the art and describe closing mechanisms in which the elements causing rotation of the roll-up device, as well as the flexible sheet, are within or are a part of one of the uprights or vertical profiles of the peripheral frame, which are in turn fixed to the building side walls, partitions or walls.

So, in order to perform any repair or replacement of the rolling mechanisms, elements or means, the peripheral frame must be dismounted, even partially, since said rolling means are housed within, being a part of one of the vertical profiles or uprights. Said uprights receive in turn, in the upper and lower ends thereof, the two upper and lower horizontal profiles or guide rails, thus making up the peripheral frame assembly.

Even when these designs have means for repairing any of the elements thereof, said operations can neither be carried out in a simple or quick manner nor be performed by the users themselves, since they require qualified professional staff. Said qualified staff must firstly determine the specific problem and then proceed to repair the part or remove it and replace it by another enclosure from the many which are commercially available, at a high cost and after a high period of time.

### DESCRIPTION OF THE INVENTION

The present invention describes a consumable and disposable cartridge system. Preferably, these cartridge are designed to be applied in laminar roller screens for baths and showers, or the like, by means of consumable and disposable cartridge featuring quick installation and replacement, all that carried out by the users themselves with neither tools nor professional aid, by means of supplementary connection means, preferably elastic, in the form of a clip or the like, which allow a quick and simple connection, just by a simple pressing action, to a peripheral frame capable of adjustment, being fixed to the side walls or walls of a bath, toilet or similar room of a building, being straight lined, right angled or curved arranged, formed by vertical profiles or uprights and horizontal profiles or telescopic and expanding guides designed to be adjusted to many different types of measures, which make up the enclosure of an open space intended for a bath, shower or the like; wherein said consumable and disposable cartridge has tubular elements integrated therein having a tubular shape and featuring dimensions similar to the height of its flexible rolling sheet, which allow a change in the path thereof, turning said straight lined path into a curved or right angled path, adjusting to any peripheral frame that the characteristic elastic connection means may feature, so as to readily receive the consumable and disposable cartridge, which is fitted with a rotating drum, for rolling a flexible sheet fixed at one end thereto and at the other end to a vertical profile being of the same height as the flexible sheet, which allows to manually pull the sheet along, making up the enclosure means of said open space and sliding along the upper and lower horizontal profiles or guides and between the vertical profiles or uprights of said peripheral frame; and at least a torsion spring acting on said drum and causing rotation thereof in the direction in which the flexible sheet rolls.

The object of the present invention is to provide the market with a new laminar screen system by means of consumable and disposable cartridges, intended to close different peripheral frames with different straight lined, right angled and curved conformations, for the closure of open spaces intended for baths, showers, and the like in a highly easy way, featuring quick installation and replacement, without being required to dismount the peripheral frames or to proceed with a repair which is sometimes impossible to carry out, by simply replacing the consumable and disposable cartridge, worn by use or by a fortuitous accident, by a new one having the same format, easily and quickly in a few minutes, thanks to its universal elastic connection in the form of a clip or the like, all that performed by the users themselves, with neither tools nor professional aid, thus enabling to keep these laminar screens in a perfect state over time due to the use of the consumable and disposable cartridge system.

There is described a consumable and disposable cartridge system, featuring quick installation and replacement thereof, which have elements which allow to make laminar roller screens for baths, showers and the like, being straight lined, right angled or curved, fitted with supplementary means, preferably elastic ones, which allow the quick connection to the peripheral frames thereof making up the open space to be enclosed, either in a straight lined, right angled or curved manner, all that being readily carried out by the users themselves, with no need of tools or qualified staff.

Essentially, the consumable and disposable cartridge further comprises:
an actuation knob connected to a torsion spring to allow, by means of the manual rotation thereof, the regulation of said spring,
a tubular casing delimiting the cartridge and housing the rotating drum and the torsion spring, provided with a longitudinal slot to let the flexible sheet in and out of said casing,
anchoring and guiding means for the spring inside the drum,
a cover for the casing end, being adapted so as to receive the detachable coupling of the actuation knob,

The rotating drum is a hollow cylinder, and said anchoring and guiding means of the torsion spring comprise an end piece, intended to be inserted into the drum by the opposite end with respect to the actuation knob, and it is provided, at one end, with a threaded area receiving the spring and with a cottered guiding section inside and along the constitutive cylinder of the drum.

The rotating drum is a hollow cylinder, and the actuation knob comprises a rod that passes through the upper cover located in the module end via a through hole thereof, and which is inserted into the cylinder determining the drum, said rod, provided at the free end thereof, being intended to be held in an inner position of a threaded area receiving the spring, the actuation knob comprising, at the end opposite to the rod, a wheel provided with radial teeth, comprising on the upper cover and on said plane wedged notches, and said wedged notches interacting in such a way that the rotation of the drum is only possible in one direction when the wheel is in contact with or adjacent to said plane of the upper cover.

The consumable and disposable cartridge is fitted with supplementary connection means so as to get a quick connection to and detachment from the peripheral frame, with neither tools nor professional aid, being all that carried out by the users themselves.

The supplementary connection means between the consumable and disposable cartridge and the peripheral frames, according to a preferred embodiment, comprise a system provided with a vertical projection from the cartridge casing, interacting with an elastic means, in the form of a clip inserted into a recess in the vertical profile or vertical upright of the peripheral frame.

In this case the vertical projection is a moulding protruding from a surface of the consumable cartridge casing, and the recess is a grooving of the vertical profile or upright of the peripheral frame, adapted to receive the moulding projecting from the casing by coupling of the elastic clips.

The connection means further comprise a second projection in the form of a partition protruding from the consumable cartridge casing, arranged parallel to the aforementioned moulding which is inserted into a slot of the same aforementioned vertical profile or upright of the peripheral frame, in such a way that these new two means described are used as guiding means for a quick connection of the consumable cartridge with the peripheral frame.

Alternatively and complementarily, the connection means between the consumable and disposable cartridge and the upright or vertical profile of the peripheral frame may comprise a Velcro® system, adhesive means, screwing means, magnets, rivets, a suspension system by means of two inverted-L elements, or other connection means between the peripheral frames and the cartridge, which allow the quick and easy replacement thereof.

The consumable and disposable cartridge has devices which act during the flexible sheet translation movement, enabling a curved conformation and full adaptation thereof to the configuration of the peripheral frames, whether straight or curved.

These devices have a tubular shape featuring the same height as the flexible sheet, which allow the conformation thereof, being part of the consumable and disposable cartridge, being responsible for the angled or curved conformation of the flexible sheet, associated to the guides or horizontal profiles of the peripheral frame; they perform the translation thereof, until they suitably locate in a determined point of the path, so as to make therein the change in the flexible sheet path and the perfect adaptation thereof to an angled or curved peripheral frame.

Other devices which are different from those mentioned above, for the conformation of the flexible sheet, are formed by angled hollow cases built in the guide rails or in the upper and lower telescopic horizontal profiles, comprising small cylindrical rollers that, operating integrally with these, make up and contain the angled or curved flexible sheet.

Every peripheral frame is fitted with guide rails or upper and lower horizontal profiles, being telescopically stretchable regardless the straight or angled conformation thereof; its stretchable design allows a precise adaptation to multiple measures in close interaction with the exclusive design of our wheels or bearings.

From the above description, it can be inferred that the suggested cartridges provide a solution being much more universal, effective, simple, quick and cost-effective, both for the installation and subsequent maintenance or replacement thereof, than the solutions known in the state of the art. Furthermore, all these actions are carried out by the users themselves with neither tools nor professional aid.

### DESCRIPTION OF THE DRAWINGS

Embodiments of the replacement cartridge object of the invention are shown in the attached drawings by way of non-limiting examples. Such drawings represent the following:

Figure 1a.—It shows a perspective view of a screen having a determined configuration, comprising the consumable and disposable cartridge.

FIG. 1b.—It shows a perspective view of a screen having a configuration different to that of FIG. 1a and comprising the consumable and disposable cartridge.

FIG. 1c.—It shows a perspective view of a screen having a configuration different to those shown in FIGS. 1a and 1b, and comprising the consumable and disposable cartridge.

FIG. 1d.—It shows a perspective view of a screen having a configuration different to those shown in FIGS. 1a and 1b, comprising the consumable and disposable cartridge.

FIG. 2.—It shows a perspective view of an exemplary embodiment of a consumable and disposable cartridge according to the invention.

FIG. 3.—It shows a perspective view, partially cut and sectioned of the consumable and disposable cartridge of FIG. 2 illustrating the composition thereof.

FIG. 4.—It shows a figure analogue to FIG. 2 illustrating another detail of the cartridge closure, in which the lower section has been removed.

FIG. 5.—It shows a perspective view of the consumable and disposable cartridge of FIG. 2 in the mounting position thereof on one of the sides of a vertical upright of a peripheral frame of the closure of an open space for any of the embodiments shown in FIGS. 1a and 1d, for a shower or a bath.

FIG. 6.—It shows a view of one of the corners, opposing with respect to FIG. 5.

FIG. 7.—It shows a selected view of a consumable and disposable cartridge.

FIG. 8.—It shows an upper plan view according to VIII of FIG. 7.

FIG. 9.—It shows an side elevation view according to IX of FIG. 7.

FIG. 10a.—It shows a partial sectional view x-x of FIG. 7, showing the consumable and disposable cartridge, detached from a side of the vertical profile, of a peripheral closure frame, of a bath or shower, by the insertion therein of elastic clips which, being actuated by a simple pressing action, receive the consumable and disposable cartridge.

FIG. 10b.—It shows a partial sectional view x-x of FIG. 7, showing the consumable and disposable cartridge, connected to a side of the vertical profile, of a peripheral closure frame, of a shower or bath, by the insertion therein of elastic clips which, being actuated by a simple pressing action, receive the consumable and disposable cartridge.

FIG. 11.—It shows an isometric view of a right angled casing which, being suitably interspersed in the horizontal profiles or guide rails or lower and upper horizontal bearings, is responsible for changing the path of the flexible roller sheet so as to configure a curved path.

FIG. 12.—It shows a sectional view of FIG. 1c, showing the design of the guide rails or upper and lower horizontal profiles for peripheral curved conformations having an arched shape, together with the retaining supports and rollers, which once introduced therein are useful for guiding the flexible sheet in the opening or closing path thereof.

FIG. 13.—It shows a sectional view of the guide rails or stretchable and telescopic upper and lower horizontal profiles, for guiding the wheels incorporated in the vertical handle of the flexible sheet.

FIG. 14.—It shows an isometric view of the same stretchable guide rails of FIG. 13 making up the open space to be enclosed.

FIG. 15.—It shows an isometric view of the wheels or bearings used in all the peripheral frames, for guiding the flexible sheet being adapted to the shape and measure of the guide rails or upper and lower horizontal profiles, with a design having two different friction and guiding areas, adapted to each one of the sections and measures of the telescopically stretchable guide rails.

### PREFERRED EMBODIMENT OF THE INVENTION

An embodiment of the consumable and disposable cartridge 200 of the invention, as well as constitutive elements and operation mode thereof are described below.

The consumable and disposable cartridge 200, which is described in the present invention is suitable for bath and shower screens and the like; its design enables the adaptation thereof to the inner and outer shapes of the screen, it can be arranged inside or outside the screen and can be left to view in the inner or outer area of the bath, shower or the like, indistinctively, according to the intended design.

The consumable and disposable cartridge 200 can be applied in closure screens having a peripheral conformation, made up by upper and lower telescopically stretchable horizontal profiles or guide rails 3-4, and vertical profiles or uprights 1-2 for the closure of an open space intended for a bath, shower, window or the like.

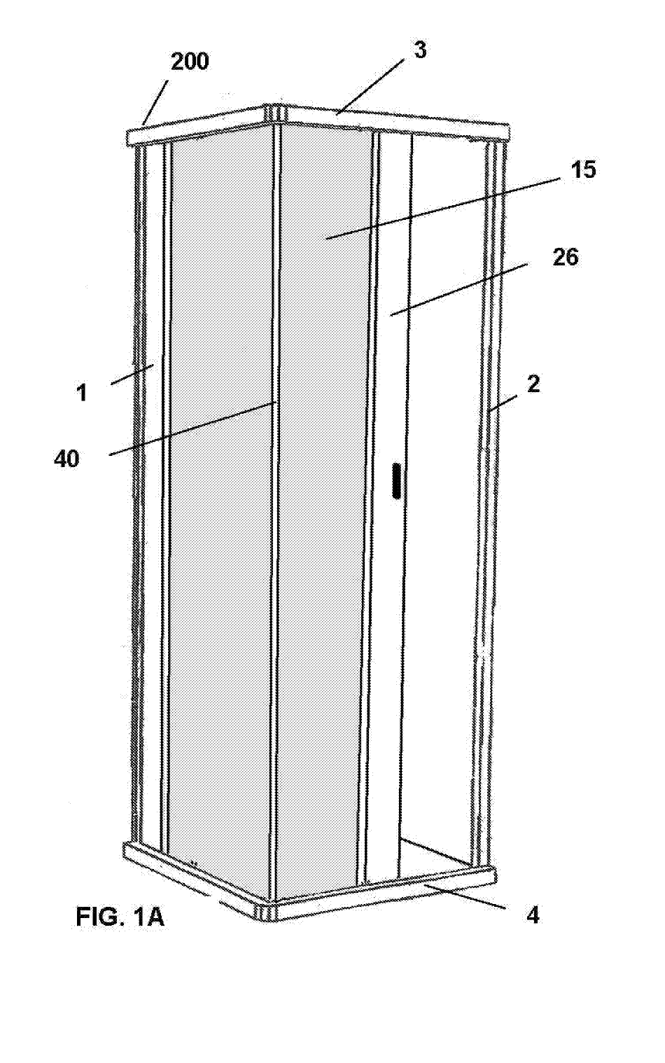

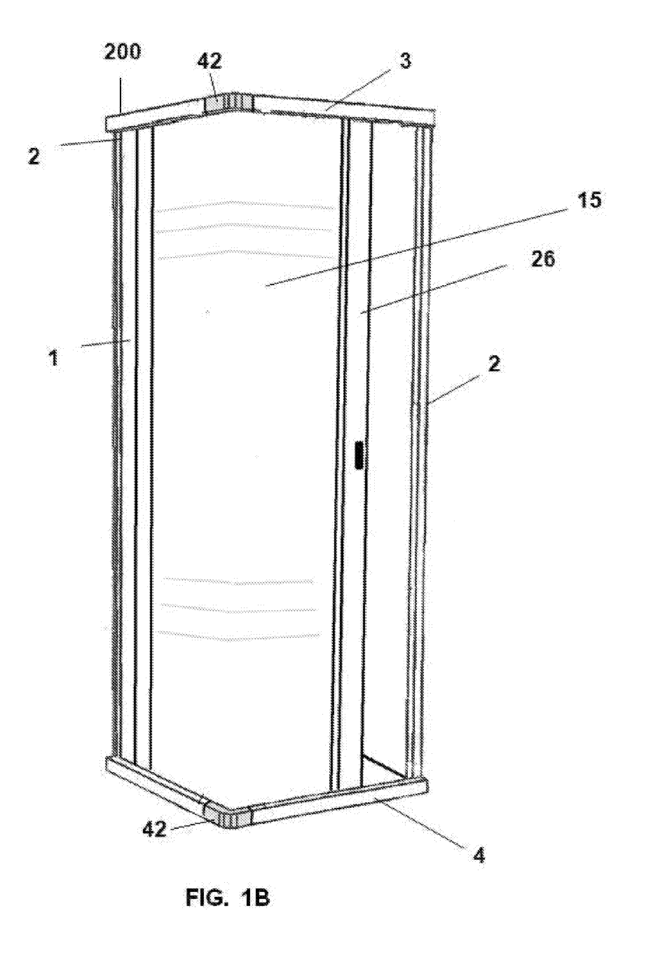

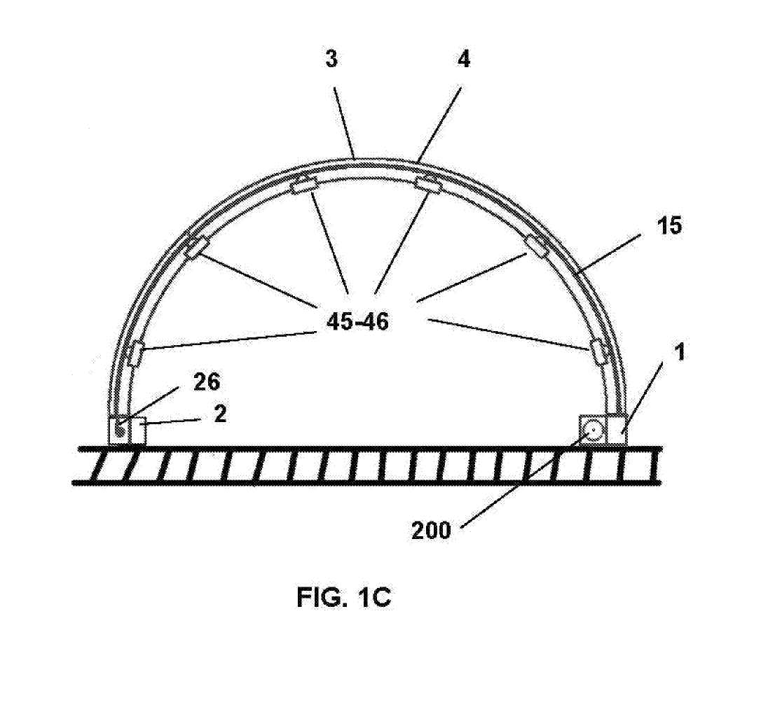

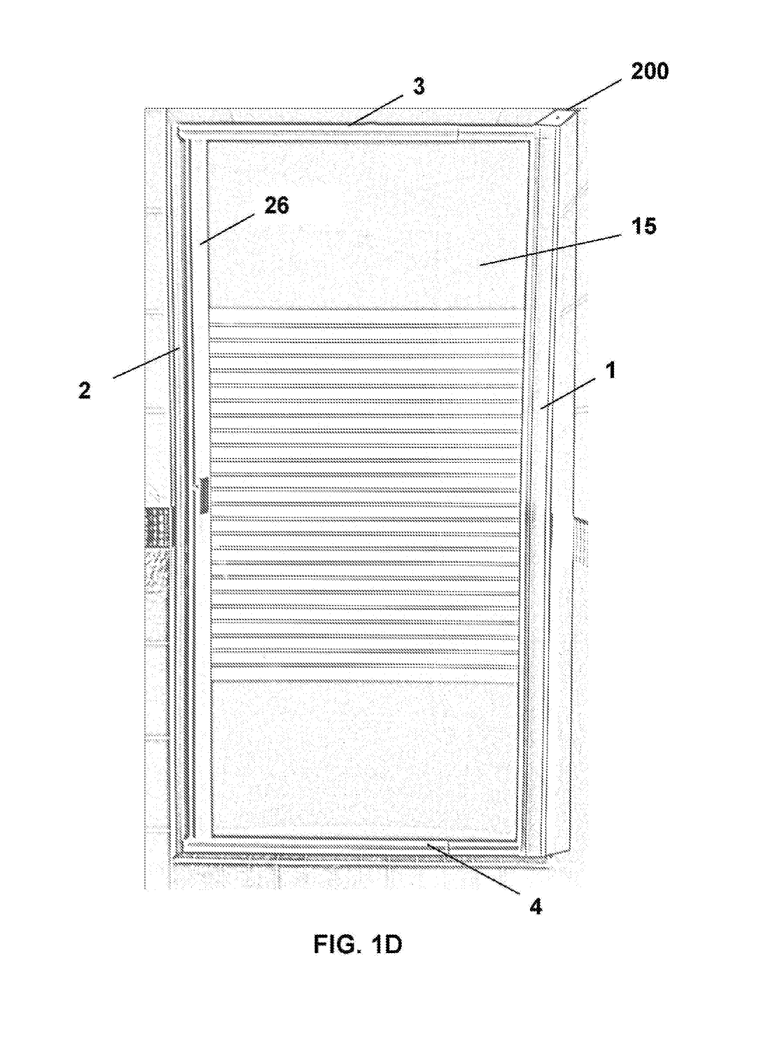

FIGS. 1a a 1d show screens having different shapes and embodiments, all of them fitted with the consumable and disposable cartridge 200, (angled in FIG. 1a, differently angled in FIG. 1b, curved in FIG. 1c and straight in FIG. 1d) for the closure of open spaces which will not only be on a single vertical plane FIG. 1d, but at least in two vertical planes being somewhat angled, (FIG. 1a) (FIG. 1b), or curved (FIG.

1c); in such case, the upper and lower horizontal profiles, 3-4, being telescopically stretchable, adopt the configuration suitable for these types of closures being somewhat angled, or curved, matching the shape of the space to be enclosed. Any of the screens according to figures la to 1d is fitted with the same consumable and disposable cartridge 200 object of the invention, being common to, and interchangeable among all of them.

The telescopic horizontal profiles 3-4, are used as guiding means for the bearings attached to the ends of the vertical handle 26, which in turn holds and facilitates to manually pull the flexible rolling sheet 15 making up the means intended for the closure of the open space, essentially vertical, that as well as being a rolling and flexible sheet, can optionally be transparent, opaque or translucent, and is inserted in the cartridge 200 forced by a torsion spring 12, and is taken out of it when it extends upon manual traction on a vertical handle 26 which is coupled to an end vertical edge of the flexible sheet 15.

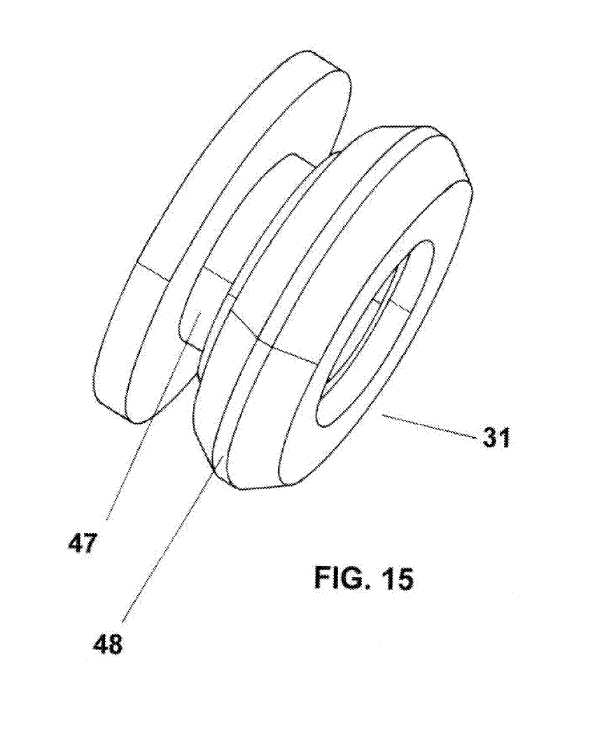

The profiles or guide rails 3-4 are telescopically stretchable in one or several sections, are built according to their specific design shown in FIG. 14 and attached by the ends thereof to the vertical profiles 1 and 2.

The sheet guiding is produced due to some bearings or wheels 31, FIG. 9-15 integral to the sheet 15, sliding along the upper and lower telescopic horizontal profiles 3-4, displacing longitudinally along them.

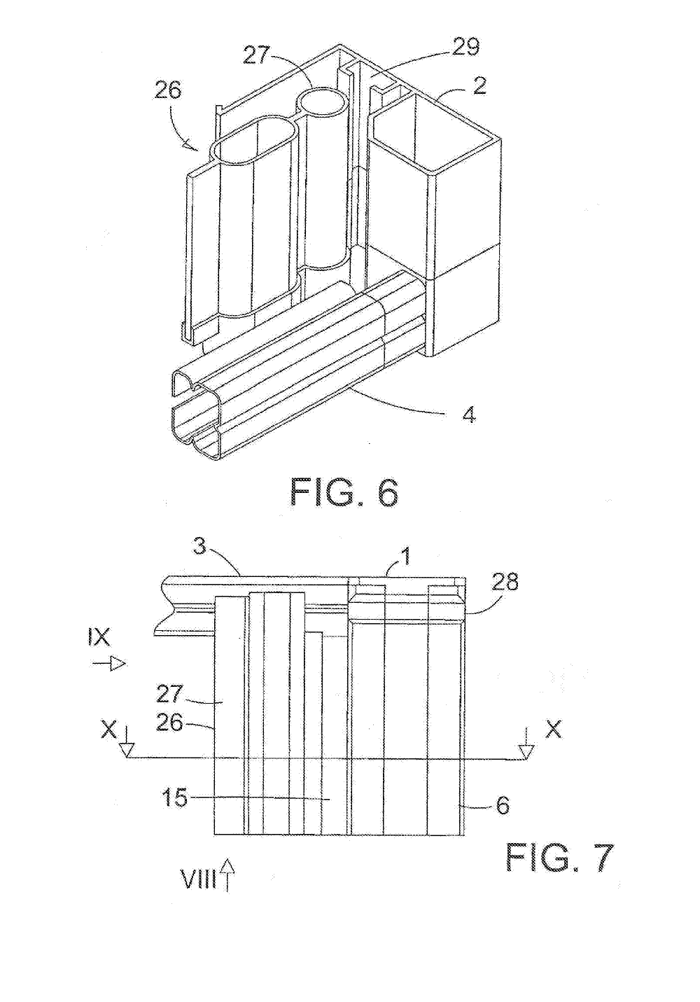

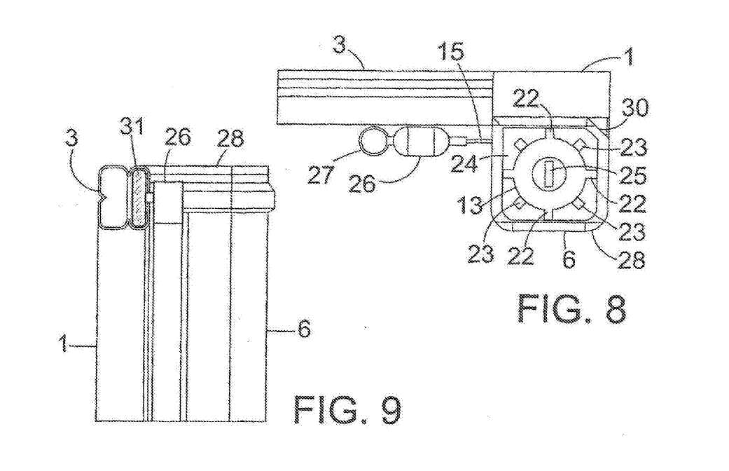

The vertical handle 26 has a plug-in moulding 27 provided to be elastically coupled to the interior of a grooving 29 which is supplementary to the vertical profile 2 for the closure of the screen under discussion. FIG. 6 represents this arrangement showing a position in which the moulding 27 is arranged outwardly with respect to the grooving 29.

The horizontal profiles 3, 4 connect with the vertical profiles 1-2 defining the peripheral frames by any conventional means. One possibility is to snap into the telescopic profile ends 3, 4 and, in turn, into the ends of the vertical profiles or uprights 1, 2, some connection supports, made of plastic or aluminium, designed to perform a strong connection.

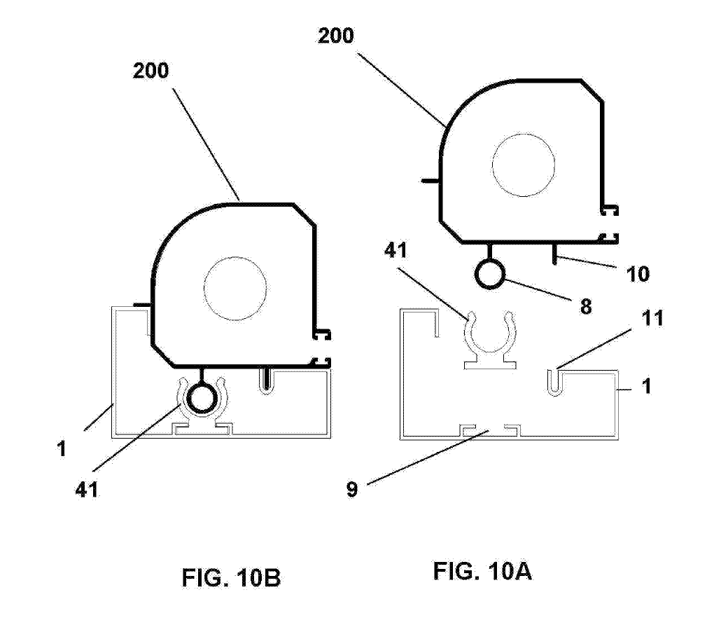

The vertical profile 1 receives, in one of its sides, the elastic means 41, and the fastening and instant replacement means of the consumable and disposable cartridge 200, FIG. 10b-10a.

The consumable and disposable cartridge 200 incorporates the following basic functional elements:
a tubular casing 6 externally delimiting the cartridge 200,
a rotating drum 5 for rolling up the flexible sheet 15. The rotating drum 5 is used for rolling and unrolling the flexible sheet 15, sliding between the upper and lower telescopic horizontal profiles 3, 4 and between the two vertical profiles or uprights 1, 2,
the torsion spring 12 which acts on said drum 5 tends to cause the rotation thereof in the rolling direction of the flexible sheet 15,
connection means, preferably in the form of an elastic clip 41, allowing, upon a simple pressing action, an instant connection of the consumable and disposable cartridge 200 to the vertical profile 1; the elastic clip 41 being intended to receive the moulding 8 of the consumable and disposable cartridge 200; wherein said clip 41 attaches to the vertical profile (1) coupling into a grooving of the profile (1),
an actuation knob 13 connected to the aforementioned torsion spring 12 so as to allow a regulation of the torsion spring 12 by means of the manual rotation thereof,
anchoring and guiding means of the spring 12 inside a drum 5,
an upper cover 28 for the casing 6 fitted to receive the detachable coupling of the actuation knob 13; a lower cover 28′, for the casing 6. Covers 28 and 28′ are mounted on the walls of the casing 6 by means of a press fit, for example of the tongue and groove type.

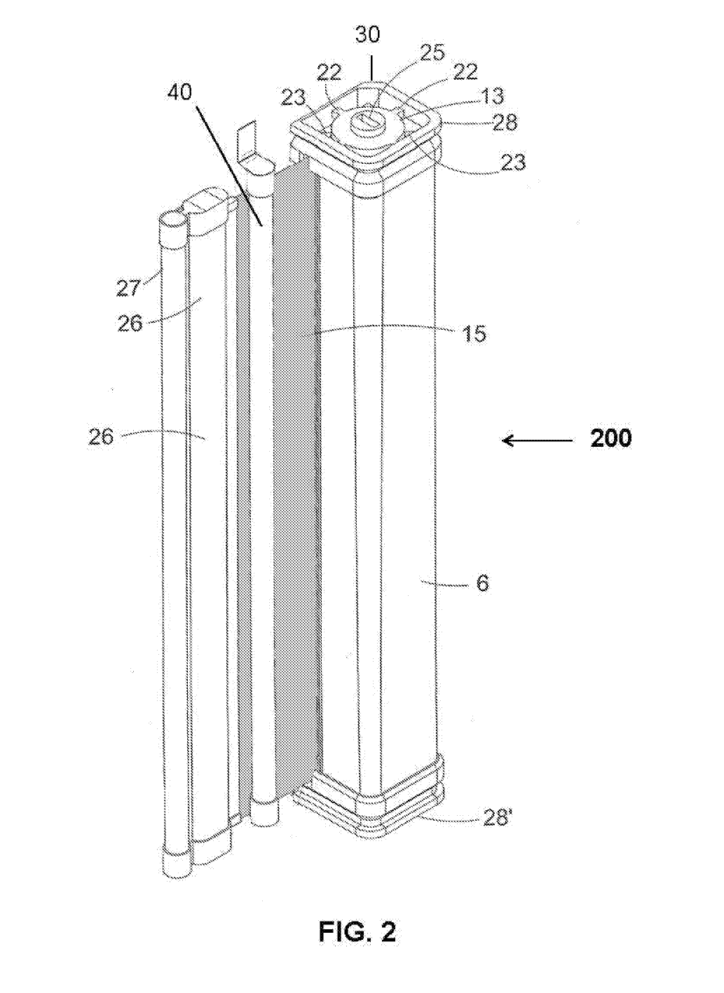

According to FIG. 2 of the invention, the consumable and disposable cartridge 200 is a compact module originally incorporating all the required elements, such as the roller sheet 15 which acts as a closure element, the actuation elements thereof, the tubular element 40 for the curved conformation of the sheet 15.

According to FIG. 1a said tubular element 40, rotating over itself, is located between the casing 6 and the handle 26, in such a way that upon actuation thereof against the handle 26, it abuts with this so as to pull the sheet 15, causing both the tubular element 40 and the handle 26 to move forward together up to a place located in the vortex of the guide rails or horizontal profiles 3 and 4, in which due to the action of stoppers situated in 3 and 4 themselves, the tubular element 40 is stopped, whereas the handle 26 keeps on pulling the sheet 15 until it gets to the end of the closure, being forced to change its path at the place where the tubular element 40 is situated.

So, if any of the elements constituting the consumable and disposable cartridge 200, constituted in a compact module including the sheet 15, the tubular element 40 and the handle 26, fails or is damaged somehow with time, it just has to be detached and replaced instantly by a new one, since it is attached to the vertical frame 1 by means of the fastening elastic means in the form of a clip 41, which act by a simple pressing action.

The aforementioned means may adopt different conformations or embodiments with different materials; in particular, the preferred connection manner, and the one which is shown in FIG. 10B-10A, consists of a fastening with an elastic means in the form of a clip 41, that when inserted in a grooving 9 of the vertical profile 1 allows the fastening by pressing the moulding 8 projecting from a side surface of the casing of the consumable and disposable cartridge 200, fitting by adjustment by means of the clip, by pressing within the grooving; the profile of the casing further comprises a partition 10 arranged parallel to the moulding 8, and the vertical profile 1 comprises a slot 11. The partition 10 is introduced in the slot 11 in such a way that the partition 10 and the slot 11 act as a guide for the introduction of the moulding in the elastic clips introduced in the grooving 9.

The moulding 8, featuring a hollow tubular shape, is part of the tubular casing 6, of the consumable cartridge 200, which can be continuous having the same length as the casing 6, or else it can be discontinuous sectioned in several lengths consecutively aligned.

Alternatively or supplementary, the connection means may comprise a Velcro® system, screwing means, adhesive means, magnets, rivets or analogue systems. It may also comprise a system having L-shaped projections in the casing of the consumable cartridge 200, and inverted-L-shaped projections in the vertical profile 1, or vice versa, interacting between them so as to vertically suspend or hang the consumable and disposable cartridge 200, in the vertical profile 1.

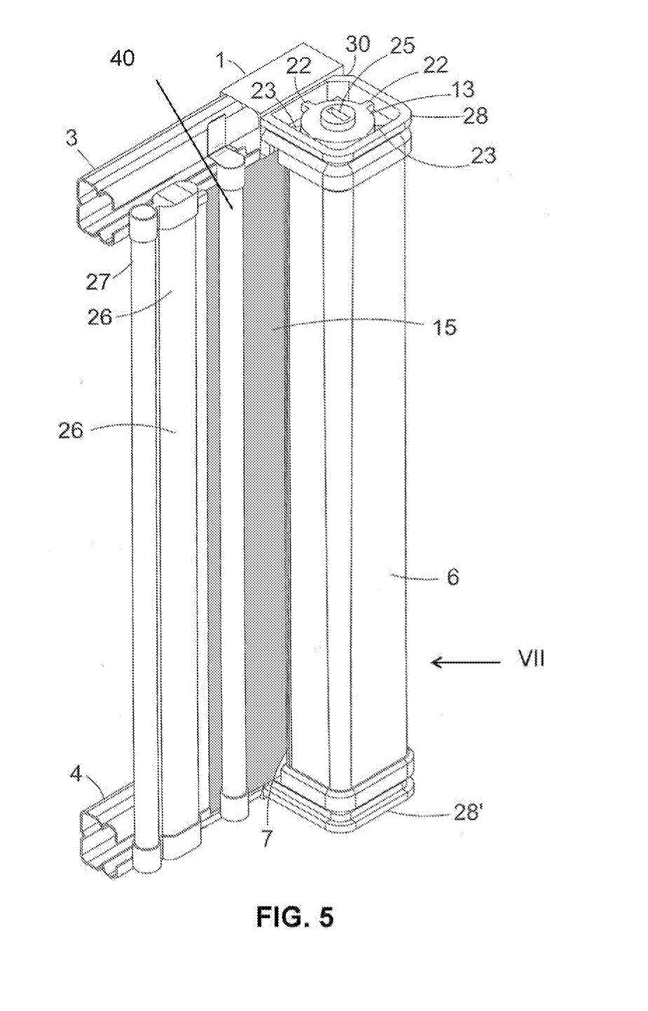

The consumable and disposable cartridge 200, has on the edge of its casing 6, a chamfer 30 being contiguous to the vertical profile 1 corner, wherein said chamfer allows the insertion of an object intended to help detach the cartridge 200 from the vertical profile 1, at the moment when it is to be removed FIG. 5.

The tubular casing 6, outwardly delimiting the cartridge 200, and housing the rotating drum 5 and the torsion spring 12, is provided with a longitudinal opening 7, having suitable length and aperture so as to allow the flexible roller sheet 15 in and out of the casing 6.

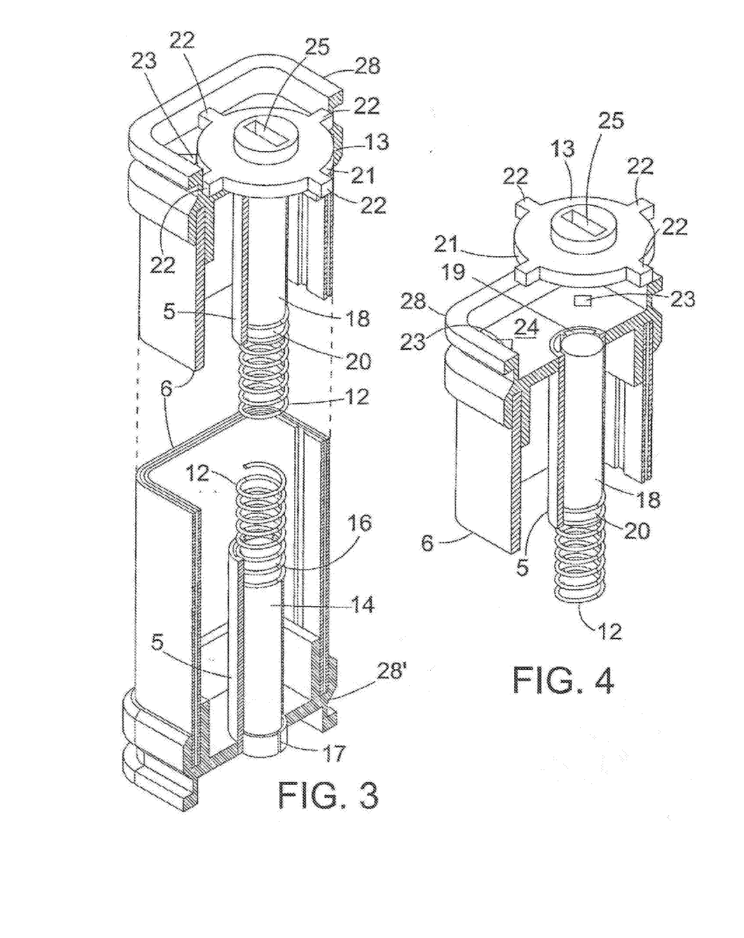

FIGS. 3 and 4 show more clearly that the rotating drum 5 is a hollow cylinder and that the anchoring and guiding means of the torsion spring 12 comprise an end piece 14 intended to be inserted in the drum 5 through the opposite end of the actuation knob 13. The end piece 14 is provided on one of its ends with a threaded area 16 receiving the spring 12, and with a cottered guiding section 17 inside and along the constitutive cylinder of the drum 5.

According to FIGS. 3 and 4, the actuation knob 13 is provided with a rod 18 that passes through the upper cover 28, via a through hole 19 thereof, and which is inserted into the cylinder determining the drum 5. The rod 18, on the free end thereof which is intended to be inwards, is provided with a threaded area 20 receiving the spring 12.

The actuation knob 13 comprises, at the end opposite to the rod, a wheel 21 provided with radial teeth 22 which can be integral to or detachable from the rod 18.

The upper cover 28 comprises, on its surface or plane 24, wedged notches 23 interacting with the radial teeth 22 as a kind of palw, that is, allowing the wheel 21 to rotate in one direction but not in the opposite direction. Thus, rotation of the drum 5 is only possible in a rotating direction when the wheel is contact with or adjacent to said plane 24 of the upper cover.

This configuration and functionality can be appreciated in further detailed in FIG. 4.

The actuation knob 13 comprises a slot 25 for it to be actuated by means of a tool intended to tighten the spring during the manufacturing process of the consumable and disposable cartridge 200.

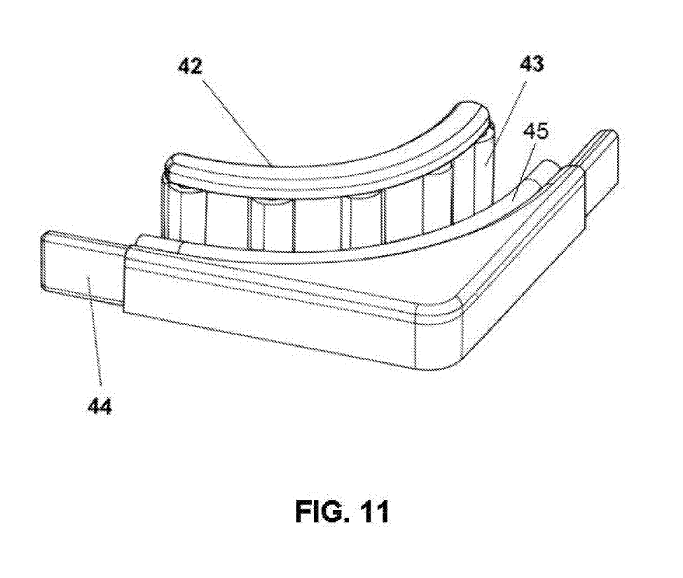

FIG. 1b shows other conformation means for the flexible sheet 15, for angled peripheral screens, by means of tubular angled casings 42 FIG. 11, being provided with rollers 43 inside, which once being positioned by inserting the ends 44 thereof into the vertexes of the guide rails or horizontal profiles 3 and 4, make it possible for a change from a straight path into an angled path of the flexible sheet 15.

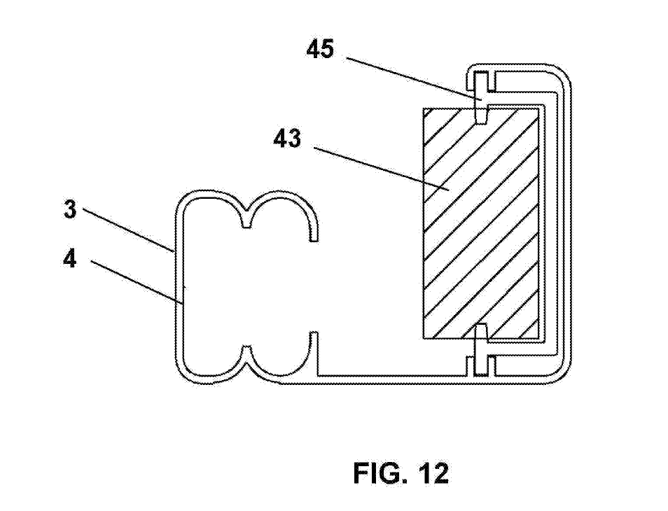

FIG. 12 describes the section of the guide rails or upper and lower horizontal profiles 3 and 4, including supports 45, and rollers 43, inserted within, which conveniently positioned are in charge of containing and guiding the flexible sheet 15 to form the curved and arched closure, according to FIG. 1C.

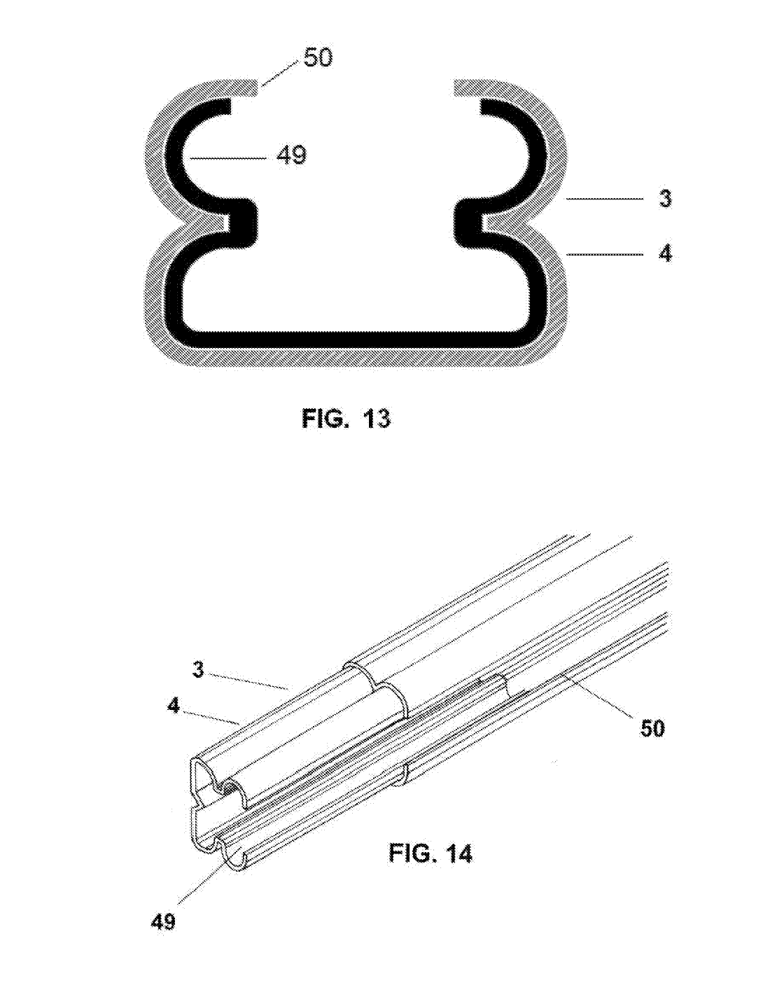

FIG. 13 corresponds to the section of the upper and lower stretchable and telescopic guide rails 3, 4.

FIG. 14 corresponds to an isometric figure of the same guide rails 3, 4, in an stretched position; the wheels 31 of FIG. 15 are inserted through the upper diameter 48 thereof in the inner side 49 of the guides 3, 4, and the inner diameter 47 of the wheels 31 slides along the vertex 50, so that when the wheel 31 passes from the smaller section of the guides 3, 4, to the biggest one, the change is compensated by the wheel 31 design, which features two specific friction areas, one for each section of the guides 3, 4.

Having sufficiently described the nature of the present invention, as well as the way it should be put into practice, it should be noted that anything which does not alter, change or modify the fundamental principle thereof is subject to detail variations.

1. A consumable and disposable cartridge for laminar screens featuring straight and curved shapes, featuring quick installation and replacement thereof, particularly applicable to shower curtains and shower screens for baths, mosquito nets, and the like,
and said consumable and disposable cartridge comprising peripheral frames formed by vertical profiles and stretchable horizontal profiles making up the closure of an open space intended for a bath, shower, window or the like,
and the consumable and disposable cartridge comprising:
a rotating drum for rolling a flexible sheet which is fixed at one end to said rotating drum and at the other end to a vertical handle being of the same height as the flexible sheet so as to facilitate pulling thereof, and the flexible sheet and the vertical handle making up the closure means for the open space and sliding along the horizontal profiles and between the vertical profiles, and
at least a torsion spring acting on that rotating drum, causing rotation thereof in the rolling direction of the flexible sheet,
and the consumable and disposable cartridge also comprising:
an actuation knob connected with the torsion spring configured to allow the regulation thereof,
a tubular casing delimiting the cartridge and housing the rotating drum inside thereof, and being provided with a slot intended for the flexible sheet to go through,
anchoring and guiding means for the spring inside the drum,
a cover, at one end of the tubular casing, adapted to receive a detachable coupling of the actuation knob,
supplementary connection means consisting of elastic clips that are to be inserted in a grooving of the vertical profile allowing the fastening by a projection projecting from a side surface of the casing of the consumable and disposable cartridge.

2. The cartridge of claim 1, wherein the rotating drum is a hollow cylinder, and in that the anchoring and guiding means of the torsion spring, comprise an end piece intended to be inserted into the drum through the end opposite to the actuation knob, and being provided on one end with a threaded area receiving the spring, and with a cottered guiding section inside and along the drum.

3. The cartridge of claim 1, wherein the rotating drum is a hollow cylinder comprising the actuation knob, a rod which passes through the upper cover, via a through hole thereof, and which is inserted into the cylinder determining the drum, being said rod provided at the free end thereof with a threaded area receiving the spring, the actuation knob comprising, at the end opposing the rod, a wheel provided with radial teeth, which can be integral to or detachable from the rod, wherein the upper cover comprises in said plane wedged notches interacting with the radial teeth, as a kind of pawl, allowing the wheel to rotate in one rotating direction and not in the opposite direction, so that rotation of the drum is only possible in one rotating direction when the wheel is adjacent contact with said plane of the upper cover.

4. The cartridge of claim 1, wherein the actuation knob, comprises a slot for its actuation from the outside during the manufacturing process.

5. The cartridge of claim 1, wherein the supplementary connection means comprise a second projection in the form of a partition, which is parallel to the first projection or moulding, located in a side surface of the casing, that is inserted into a slot or second grooving, which is parallel to the first grooving of the vertical upright, of the peripheral frame, intended to receive the partition, or second projection, of the casing side of the consumable and disposable cartridge, closely interacting for a higher security in the connection of the assembly.

6. (canceled)

7. The cartridge of claim 1, wherein the section of the upper and lower horizontal profiles 3, 4, includes rollers having supports which are inside the guide rails, and which are intended to guide the flexible sheet to form the curved and arched closure.

8. The cartridge of claim 1, wherein the supplementary connection means may comprise a Velcro® system.

9. The cartridge of claim 1, wherein the supplementary connection means may comprise L-shaped projections situated in the cartridge casing, interacting with other inverted L-shaped projections situated in the vertical profile or upright of the peripheral frame, in such a way that the connection is carried out by suspending the consumable and disposable cartridge, in the vertical profile.

10. The cartridge of claim 1, wherein the supplementary connection means may comprise adhesive means.

11. The cartridge of claim 1, wherein the supplementary connection means may comprise magnets.

12. The cartridge of claim 1, wherein the supplementary connection means may comprise screws or rivets.

13. The cartridge of claim 1, wherein the consumable and disposable cartridge casing is attached vertically and parallel to the peripheral frame at least in one of the sides of the uprights or vertical profiles of said peripheral frame.

14. The cartridge of claim 1, wherein the stretchable horizontal profiles consist of two profiles having the same design and different measures, which allow the insertion of one of them inside the other, being possible for it to slide inside thereof, and in that the cartridge comprises wheels and bearings comprising two friction diameters, an upper one adapted to the inner diameter of the stretchable guides, and a lower diameter adapted to a vertex of the stretchable horizontal profiles.

15. The cartridge of claim 1, wherein it comprises means of tubular angled casings provided with rollers inside, which comprise ends thereof configured to be inserted into the vertexes of the guide rails or horizontal profiles for a change from a straight path into an angled path of the flexible sheet.
